(19) United States
(12) Patent Application Publication
(10) Pub. No.: US 2009/0245679 A1
(43) Pub. Date: Oct. 1, 2009

(54) IMAGE PROCESSING APPARATUS

(76) Inventors: Kazuyasu OHWAKI, Kanagawa (JP); Goh ITOH, Tokyo (JP); Kenichi SHIMOYAMA, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/406,395

(22) Filed: Mar. 18, 2009

(30) Foreign Application Priority Data
Mar. 27, 2008 (JP) 2008-084586

(51) Int. Cl. G06K 9/40

(52) U.S. Cl. 382/260

(57) ABSTRACT

An image processing apparatus calculates an absolute difference in pixel values between each pixel (target pixel) of the image and each of neighboring pixels of the target pixel, and a sum of the absolute differences with respect to the target pixel, calculates a threshold using the sum of the absolute differences with respect to the target pixel and a weight previously determined, the threshold being used as a reference for determining whether the pixel values of the neighboring pixels are used in a smoothing process for the target pixel, and performing a smoothing process by means of an edge-preserving smoothing filter, based on whether the absolute difference in pixel values between the target pixel and each of the neighboring pixels of the target pixel exceeds the threshold.

### CROSS-REFERENCE TO RELATED APPLICATIONS

This application is based upon and claims the benefit of priority from the prior Japanese Patent Application No. 2008-084586, filed on Mar. 27, 2008; the entire contents of which are incorporated herein by reference.

### BACKGROUND OF THE INVENTION

1. Field of the Invention

The present invention relates to an image processing apparatus.

2. Description of the Related Art

Edge-preserving low-pass filters that perform a smoothing process for image data while preserving edges of the image data have been conventionally proposed. Recently, various techniques that are applied to the edge-preserving filters are proposed.

For example, JP-A 2003-8935 (KOKAI) proposes a technique that enables to set a threshold according to edge strength in an epsilon filter, which is a nonlinear filter having a high capability of preserving edges. More specifically, control is performed in such a manner that a threshold to be used by the epsilon filter is set low when edge strength of image data is high, and the threshold is set high when the edge strength is low. When filtering is performed by the epsilon filter using the threshold, object boundaries can be preserved.

However, high edge strength is usually detected when the image data includes noises, as well as when the image data includes edges. Therefore, when the technique as described in JP-A 2003-8935 (KOKAI) is applied, the edge strength becomes high when the image data includes noises, and thus the threshold is set low. Accordingly, the noises are adversely preserved, as well as the edges of the image data.

### SUMMARY OF THE INVENTION

According to one aspect of the present invention, an image processing apparatus includes an input unit that inputs an image, a difference calculating unit that calculates an absolute difference in pixel values between each pixel (target pixel) of the image and each of neighboring pixels of the target pixel, and a sum of the absolute differences with respect to the target pixel, a threshold calculating unit that calculates a threshold using the sum of the absolute differences with respect to the target pixel and a weight previously determined, the threshold being used as a reference for determining whether the pixel values of the neighboring pixels are used in a smoothing process for the target pixel, and a filtering unit that performs a smoothing process by means of an edge-preserving smoothing filter, based on whether the absolute difference in pixel values between the target pixel and each of the neighboring pixels of the target pixel exceeds the threshold.

According to another aspect of the present invention, an image processing apparatus includes an input unit that inputs an image, a smoothing filtering unit that performs a smoothing process for a luminance value included in the image by means of a smoothing filter, to generate smoothing information of each pixel, a difference calculating unit that calculates an absolute difference in pixel values between each pixel (target pixel) in the image and each of neighboring pixels of the target pixel, and a sum of the absolute differences with respect to the target pixel, a threshold calculating unit that calculates a threshold using the sum of the absolute differences of the target pixel and a weight previously determined, the threshold being used as a reference for determined whether the pixel values of the neighboring pixels are used in a smoothing process for the target pixel, an adjustment filtering unit that performs a smoothing process using the pixel value of the target pixel as the pixel value of each of the neighboring pixels of the target pixel, having the absolute difference in pixel values between the target pixel and the neighboring pixel lower than the threshold, to generate adjustment information, a contrast-component generating unit that divides the pixel value of each pixel in the image by the adjustment information to generate contrast component information of each pixel of the image, and an image synthesizing unit that multiplies the contrast component information by the smoothing information to generate synthesized image.

### BRIEF DESCRIPTION OF THE DRAWINGS

FIG. 1 is a block diagram of a configuration of an image processing apparatus according to a first embodiment of the present invention;

FIG. 2 is a schematic diagram for explaining a block of 5×5 pixels;

FIG. 3 is a conceptual diagram of setting of a threshold based on definition and determination of impulse noises;

FIG. 4 is an example of the block of 5×5 pixels before being processed by an epsilon filter;

FIG. 5 is an example of the block of 5×5 pixels after being processed by the epsilon filter;

FIGS. 6A and 6B are schematic diagrams for explaining a threshold calculated by a threshold calculating unit when a signal level has large amplitude;

FIGS. 7A and 7B are conceptual diagrams of a result of a smoothing process performed by an edge-preserving filtering unit when a signal level has large amplitude;

FIGS. 8A and 8B are schematic diagrams for explaining a threshold calculated by the threshold calculating unit when a signal level has small amplitude;

FIGS. 9A and 9B are conceptual diagrams of a result of a smoothing process performed by the edge-preserving filtering unit when a signal level has small amplitude;

FIG. 10 is a schematic diagram for explaining a threshold calculated by the threshold calculating unit when there is an edge;

FIGS. 11A and 11B are conceptual diagrams of a result of a smoothing process performed by the edge-preserving filtering unit when there is an edge;

FIGS. 12A and 12B are schematic diagrams for explaining a threshold calculated by the threshold calculating unit when there is an impulse noise;

FIGS. 13A and 13B are conceptual diagrams of a result of a smoothing process performed by the edge-preserving filtering unit when there is an impulse noise;

FIG. 14 is a flowchart of a general process procedure performed by the image processing apparatus according to the first embodiment;

FIG. 15 is a flowchart of a procedure of calculating a difference average, performed by a difference calculating unit according to the first embodiment;

FIG. 16 is a flowchart of a smoothing process procedure performed by an edge-preserving filtering unit according to the first embodiment;

FIG. 17 is a block diagram of a configuration of an image processing apparatus according to a second embodiment of the present invention;

FIG. 18 is a flowchart of a general process procedure performed by the image processing apparatus according to the second embodiment;

FIG. 19 is a flowchart of a smoothing process procedure performed by an edge-preserving filtering unit according to the second embodiment;

FIG. 20 is a block diagram of a configuration of an image processing apparatus according to a third embodiment of the present invention;

FIG. 21 is a block diagram of a configuration of an image processing apparatus according to a first modification of the third embodiment;

FIG. 22 is a block diagram of a configuration of an image processing apparatus according to a second modification of the third embodiment;

FIG. 23 is a block diagram of a configuration of an image processing apparatus according to another modification of the present invention; and

FIG. 24 depicts a hardware configuration of an image processing apparatus according to the present invention.

### DETAILED DESCRIPTION OF THE PREFERRED EMBODIMENTS

Exemplary embodiments of an image processing apparatus according to the present invention will be explained below in detail with reference to the accompanying drawings.

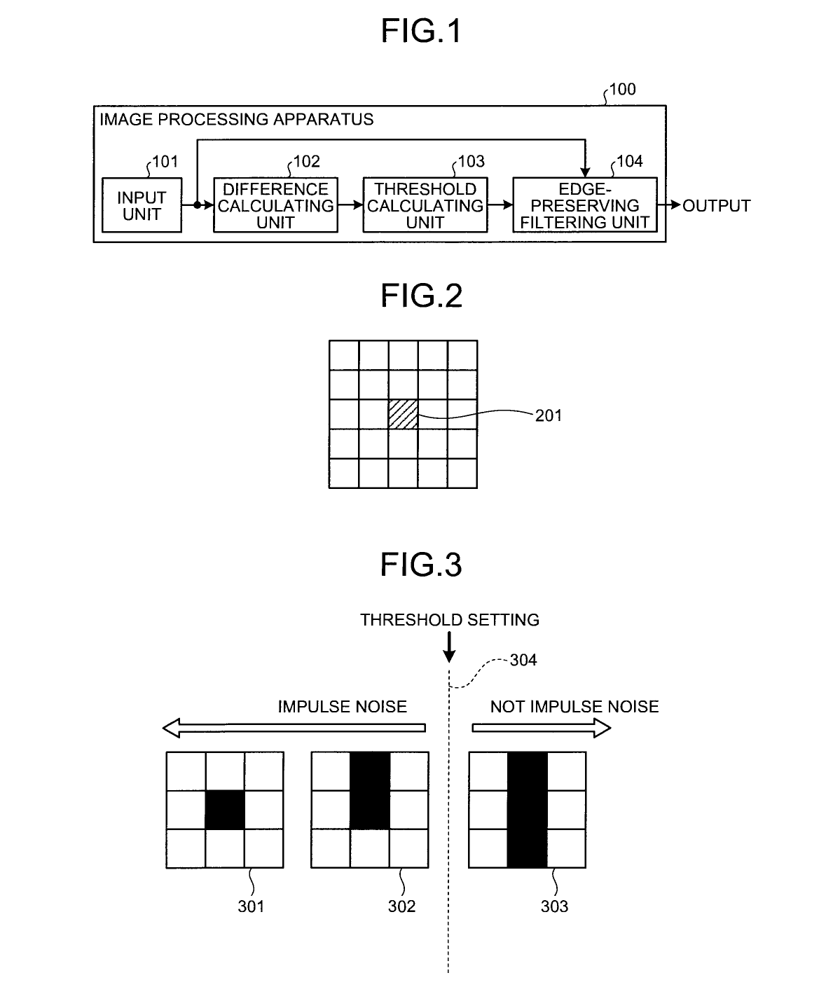

As shown in FIG. 1, an image processing apparatus 100 according to a first embodiment of the present invention includes an input unit 101, a difference calculating unit 102, a threshold calculating unit 103, and an edge-preserving filtering unit 104. The image processing apparatus 100 performs an edge-preserving noise-reducing process to image data.

The input unit 101 inputs image data. The input unit 101 inputs image data from any device or medium. For example, the input unit 101 can input image data from a recording medium such as a hard disk drive (HDD), or image data from an external device connected via a network.

The difference calculating unit 102 calculates an absolute value of a difference between a smoothing target pixel included in the image data, which is regarded as a center pixel, and each of neighboring pixels around the center pixel, and an absolute difference sum indicating a sum of the absolute differences with respect to the center pixels. The difference calculating unit 102 then divides the calculated absolute difference sum by the number of neighboring pixels to calculate a difference average Ave of the neighboring pixels.

In the first embodiment, as shown in FIG. 2, a pixel at the center of a block of 5×5 pixels included in the image data is regarded as a center pixel 201 to be a target for a smoothing process, and other 24 pixels are regarded as the neighboring pixels.

In the first embodiment, the absolute difference sum is not the only value to be used as the difference between the center pixel and the neighboring pixels, and other values can be used instead. As a modification, the difference calculating unit 102 can calculate a difference square sum between the center pixel and the neighboring pixels, and divide the calculated sum by the number of neighboring pixels to calculate a difference average. In this case, the threshold calculating unit 103 (which is explained later) and the like perform processes by using the calculated difference average.

The threshold calculating unit 103 multiplies the difference average Ave of the neighboring pixels by a predetermined weight ω, to calculate a threshold th to be used as a reference for edge preserving. The threshold th is calculated with respect to each center pixel. The threshold th is used as a reference for determining whether pixel values of the neighboring pixels are used in a smoothing process for each center pixel. The following formula (1) is used to calculate the threshold th.

Threshold th=Difference average Ave of neighboring pixels×Weight ω (1)

The multiplication is not the only operation performed by the threshold calculating unit 103 using the difference average Ave and the weight ω, and other operations such as addition can be used instead. In addition, the calculation of the threshold th can be performed by using the absolute difference sum before division by the number of neighboring pixels, instead of the difference average Ave. This is because the same effect can be obtained by changing the weight.

The weight ω is previously determined at a stage of defining noises to be removed. The weight ω according to the first embodiment is previously calculated based on an absolute difference sum of edges and an absolute difference sum of noises when the neighboring pixels of each center pixel are divided into edges and noises according to the number of neighboring pixels having the absolute difference equal to or higher than a predetermined value. A method of setting the weight ω is explained. In the first embodiment, a threshold setting method performed when an edge-preserving filter that performs a smoothing process for pixels having values equal to or lower than a threshold, and does not perform a smoothing process for pixels having values higher than the threshold is used is explained.

For ease of explanation, an example in which a threshold is set using blocks each consisting of 3×3 pixels as shown in FIG. 3 is considered. A designer of the image processing apparatus 100 first defines a reference for determining whether there is an impulse noise. In the example shown in FIG. 3, it is assumed that the designer defines that black pixels in pixel blocks 301 and 302 are impulse noises, and black pixels in a pixel block 303 are not impulse noises.

According to this definition, a value that enables to calculate a threshold for removing the black pixels in each of the blocks on the left side of a line 304, and for keeping the black pixels in the block on the right side of the line 304 needs to be set for the weight. A specific range of the weight that can be set is calculated.

It is assumed that a difference in levels between white pixels and black pixels shown in FIG. 3 is x, and that the weight to be set is ω. In this example, when the difference average between the center pixel and the neighboring pixels is calculated by the difference calculating unit 102, the difference average AveA of the pixel block 301 is x, the difference average AveB of the pixel block 302 is 7x/8, and the difference average AveC of the pixel block 303 is 6x/8. The level difference x is a value previously determined as a signal level for determining that there is a impulse noise, in other words, as an absolute value of a difference in pixel values.

When thresholds are calculated from these difference averages, a threshold thA of the pixel block 301 is ωx, a threshold thB of the pixel block 302 is 7ωx/8, and a threshold thC of the pixel block 303 is 6ωx/8. When an actual threshold is equal to or higher than the thresholds thA and thB, the black pixels in the pixel blocks 301 and 302 are removed as noises. When an actual threshold is equal to or lower than the threshold thC, the black pixels in the pixel block 303 remain as those not being noises. That is, x needs to meet a condition as expressed by a formula (2).

thB>x>thC (2)

More specifically, when the level difference x between the white pixels and the black pixels is equal to or larger than thB and equal to or smaller than thC, the noise removal as mentioned above is allowed. A formula (3) is obtained by converting the formula (2).

7ωx/8>x>6ωx/8 (3)

A range of the weight ω that satisfies the formula (3) is 1.1428<ω<1.3333. When the weight ω is set within this range, the black pixels in the pixel blocks 301 and 302 can be removed as impulse noises, and the black pixels in the pixel block 303 can be kept.

In the first embodiment, the weight ω is set at 1.25 for convenience of processing.

The threshold calculating unit 103 according to the first embodiment thus multiplies the difference average Ave of the neighboring pixels by 1.25, to calculate the threshold th.

In this way, when the difference average Ave between the center pixel and the neighboring pixels is larger, a larger value is set for the threshold th, and when the difference average Ave is smaller, a smaller value is set for the threshold th.

When the threshold th calculated by the threshold calculating unit 103 is a smaller value, the number of pixels having values within the threshold th among the pixels in the pixel block becomes smaller, and therefore the number of pixels to be replaced with the pixel value of the center pixel becomes larger. Accordingly, the pixel block is smoothed to a value nearer to the pixel value of the center pixel. On the other hand, when the threshold th is a larger value, the number of pixels having values within the threshold th among the pixels in the pixel block becomes larger, and thus the number of pixels to be replaced with the pixel value of the center pixel becomes smaller. Accordingly, the pixel block is smoothed to a value near to the average pixel value of the pixels in the pixel block.

As described above, the threshold th is calculated using the difference average Ave. When there is an edge where the signal level abruptly increases in the pixel block, a pixel corresponding to the edge has a pixel value larger than the difference average Ave. Accordingly, when the pixel corresponding to the edge is a neighboring pixel, the edge-preserving filtering unit 104 (which is explained later) replaces the pixel value of the neighboring pixel with the pixel value of the center pixel, and performs the smoothing process without using the pixel value of the pixel corresponding to the edge as the neighboring pixel. Accordingly, the edge is preserved.

The edge-preserving filtering unit 104 performs the smoothing process with an edge-preserving smoothing filter with respect to each center pixel based on whether the absolute difference in pixel values between the center pixel and each of the neighboring pixels of the center pixel exceeds the calculated threshold th.

In the first embodiment, an example in which an epsilon filter is used as the edge-preserving filter is explained.

The epsilon filter obtains an absolute difference in signal levels between a center pixel of a block to be filtered and a neighboring pixel thereof. The epsilon filter holds the pixel value of the neighboring pixel when the absolute difference is equal to or lower than the calculated threshold th (also referred to as “epsilon value”), and replaces the value of the neighboring pixel with the value of the center pixel when the absolute difference is larger than the threshold th, and then performs the smoothing process. The threshold th is used to indicate whether the pixel value is to be replaced. A larger value is set for the threshold th when the difference average between the center pixel and the neighboring pixels is larger, and a smaller value is set for the threshold th when the difference average is smaller.

In the first embodiment, the edge-preserving filter is not limited to the epsilon filter, and any edge-preserving filter can be applied.

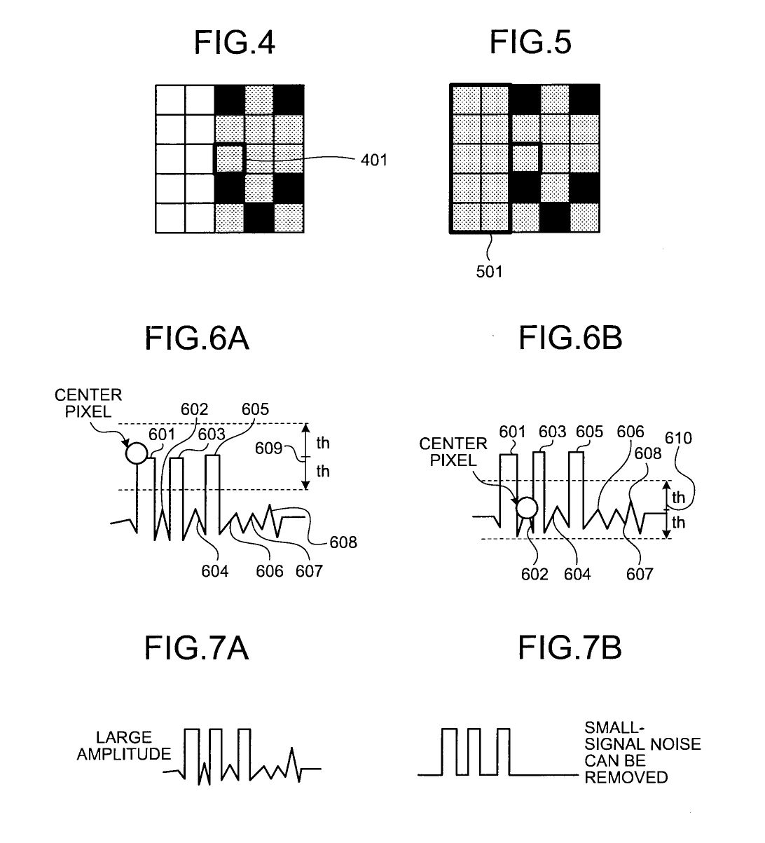

In a block before filtering shown in FIG. 4, a center pixel 401 in a block of the kernel size consisting of 5×5 pixels is grey, and the neighboring pixels are white, grey, and black. In this example, the black pixel has an absolute difference from the grey pixel, equal to or lower than the epsilon value, and the white pixel has an absolute difference from the grey pixel, higher than the epsilon value.

When performing an epsilon filtering process to the block shown in FIG. 4, the edge-preserving filtering unit 104 generates a block of 5×5 pixels as shown in FIG. 5. That is, the black pixels are not particularly processed, and the white pixels are replaced with the value of the center grey pixel (area 501). Upon completion of the filtering process, the edge-preserving filtering unit 104 performs a smoothing process to the block of 5×5 pixels, to determine a pixel value of the center pixel 401.

As described above, when the difference in pixel values from the neighboring pixel is larger, the threshold th becomes larger. The edge-preserving filtering unit 104 uses this threshold th, thereby performing a smoothing process that enables to remove a pixel when the center pixel is an impulse noise, or the like. On the other hand, when the difference in pixel values from the neighboring pixel is smaller, the threshold th becomes smaller. The edge-preserving filtering unit 104 uses this threshold th, thereby performing a smoothing process that enables to preserve an edge, or the like. The threshold th is calculated using the weight ω as mentioned above, and this implies that a value that enables to properly distinguish impulse noises and edges is set. That is, the image processing apparatus 100 according to the first embodiment can perform a smoothing process that enables to remove impulse noises and preserve edges included in image data.

In FIGS. 6A and 6B, the pixels are represented on the abscissa axis, and the signal levels are represented on the ordinate axis. Pixels 601, 603, and 605 are signals, and pixels 602, 604, 606, 607, and 608 are small-signal noises. When the center pixel is the pixel 601 as shown in FIG. 6A, a range denoted by reference numeral 609 is set for the threshold th. Therefore, the filter used in the first embodiment replaces the pixels 602, 604, 606, 607, and 608 that are not included in the range 609 with the pixel 601. The edge-preserving filtering unit 104 performs the smoothing process using pixel values of the pixels 601, 603, and 605 in the range 609, and the pixel values of the replacement pixel 601.

When the center pixel is then the pixel 602 as shown in FIG. 6B, a range denoted by reference numeral 610 is set for the threshold th. Therefore, the filter used in the first embodiment replaces the pixels 601, 603, and 605 out of the range 610 with the pixel 602. The edge-preserving filtering unit 104 performs the smoothing process using the pixel values of the pixels 602, 604, 606, 607, and 608 in the range 610, and the pixel values of the replacement pixel 602.

Therefore, the signal levels of the image data as shown in FIG. 7A is outputted as signal levels of image data shown in FIG. 7B according to the smoothing process performed by the edge-preserving filtering unit 104. As shown in FIG. 7B, the small-signal noises can be removed while the signals having large amplitude are kept. Because the threshold th is calculated using the weight ω and the difference average Ave, a larger value is set for the threshold th when the amplitude of the signal levels is larger. However, because the weight ω is set based on the reference mentioned above, the signal levels of the signals having large amplitude can be kept.

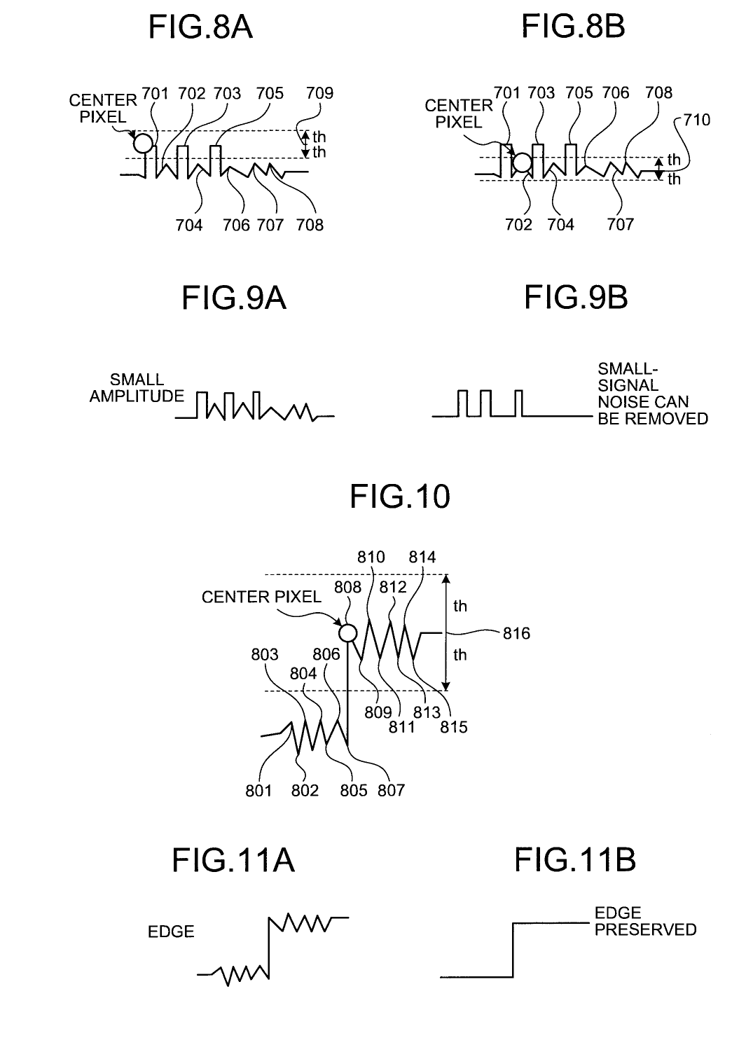

In FIGS. 8A and 8B, pixels 701, 703, and 705 are signals, and pixels 702, 704, 706, 707, and 708 are small-signal noises. When the center pixel is the pixel 701 as shown in FIG. 8A, a range denoted by reference numeral 709 is set for the threshold th. Therefore, the filter used in the first embodiment replaces the pixels 702, 704, 706, 707, and 708 out of the range 709 with the pixel 701. The edge-preserving filtering unit 104 performs the smoothing process using pixel values of the pixels 701, 703, and 705 within the range 709, and the pixel values of the replacement pixel 701.

When the center pixel is then the pixel 702 as shown in FIG. 8B, a range denoted by reference numeral 710 is set for the threshold th. Therefore, the filter used in the first embodiment replaces the pixels 701, 703, and 705 out of the range 710 with the pixel 702. The edge-preserving filtering unit 104 performs the smoothing process using the pixel values of the pixels 702, 704, 706, 707, and 708 within the range 710, and the pixel values of the replacement pixel 702.

Therefore, the signal levels of the image data as shown in FIG. 9A is outputted signal levels of image data as shown in FIG. 9B, according to the smoothing process performed by the edge-preserving filtering unit 104. As shown in FIG. 9B, small-signal noises can be removed while the signals having small amplitude are kept. Because the threshold th is calculated using the weight ω and the difference average Ave, a smaller value is set for the threshold th when the amplitude of the signal levels is smaller. However, the weight ω is set based on the reference mentioned above, and therefore the signal levels of the signals having small amplitude can be kept.

FIG. 10 is an example of signals that abruptly change into high values at a predetermined position, in which small changes as shown by pixels 801 to 807 before the change of the signal level into high values are small-signal noises. Small changes as shown by pixels 808 to 815 after the change into the high values are also small-signal noises.

As shown in FIG. 10, when the center pixel is the pixel 808, a range denoted by reference numeral 816 is set for the threshold th. Therefore, the filter used in the first embodiment replaces the pixels 801 to 807 out of the range 816 with the pixel 808. The edge-preserving filtering unit 104 performs the smoothing process using pixel values of the pixels 808 to 815 within the range 816, and the pixel values of the replacement pixel 808.

Therefore, the signal levels of the image data as shown in FIG. 11A are outputted as signal levels of image data as shown in FIG. 11B, according to the smoothing process performed by the edge-preserving filtering unit 104. That is, the difference average Ave to be used in the smoothing process is calculated between the signal levels of the pixels before the signal levels are changed into high values, and the signal levels of the pixels after the signal levels are changed into the high levels. By using the threshold th calculated based on this difference average Ave, when the center pixel is a pixel after the signal levels are changed into high values, the pixel values of the pixels before the change of the signal levels are replaced with the pixel value of the center pixel. Accordingly, an edge included in the image data can be kept. When the center pixel is a pixel before the signal levels are changed into high levels, the edge can be also kept for the same reason. In other words, small-signal noises can be removed while the edge is kept, as shown in FIG. 11B.

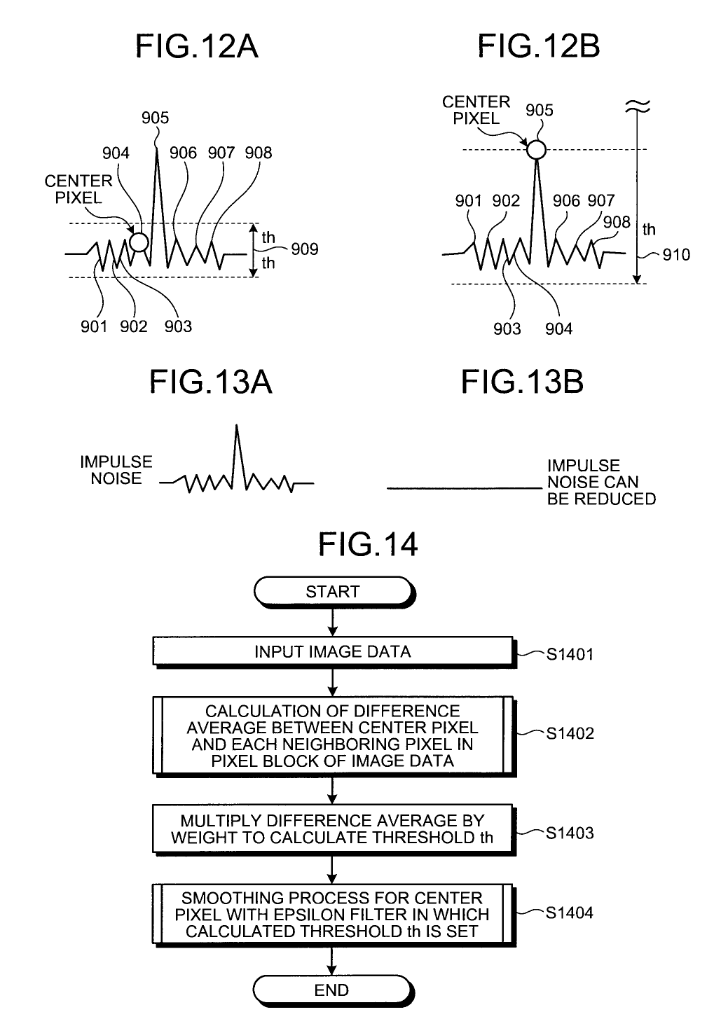

FIGS. 12A and 12B are examples in which small changes between pixels 901 to 904 are small-signal noises, a pixel 905 is an impulse noise, and small changes between pixels 906 to 908 are small-signal noises. As shown in FIG. 12A, when the center pixel is the pixel 904, a range denoted by reference numeral 909 is set for the threshold th. Therefore, the filter used in the first embodiment replaces the pixel 905 out of the range 909 with the pixel 904. The edge-preserving filtering unit 104 performs the smoothing process using pixel values of the pixels 901 to 904, 906, and 907 within the range 909, and the pixel values of the replacement pixel 904.

Thereafter, when the center pixel is then the pixel 905 as shown in FIG. 12B, a range denoted by reference numeral 910 is set for the threshold th. Therefore, the filter used in the first embodiment does not perform replacement of pixel values because all the pixels 901 to 908 are included in the range 910. Accordingly, the edge-preserving filtering unit 104 performs the smoothing process using the pixel values of the pixels 901 to 908 in the range 910.

Therefore, the signal levels of image data as shown in FIG. 13A are outputted as signal levels of image data as shown in FIG. 13B, according to the smoothing process performed by the edge-preserving filtering unit 104. As shown in FIG. 13B, the impulse noise and the small-signal noises can be removed.

As described above, when the impulse noise is the center pixel like in the example as mentioned above, the absolute difference in pixel values between the center pixel and each of all other pixels within the pixel block becomes larger. Accordingly, the threshold calculating unit 103 calculates the threshold th having a quite large value. In this case, the edge-preserving filtering unit 104 does not replace the pixel values of the neighboring pixels in the pixel block with the pixel value of the center pixel. Therefore, the pixel values of the pixels in the pixel block remain. When the edge-preserving filtering unit 104 performs the smoothing process to such pixel block using the pixels in the pixel block, a pixel value near the pixel values of the neighboring pixels is obtained, and thus the impulse noise is removed.

A general process procedure performed by the image processing apparatus 100 according to the first embodiment is explained next with reference to FIG. 14.

The input unit 101 first performs a process of inputting image data (Step S1401).

The difference calculating unit 102 then calculates a difference average of a pixel block included in the image data as an average value of absolute differences between a center pixel and the neighboring pixels (Step S1402). Processes at Steps S1402 to S1404 are performed for each of center pixels, with regarding all pixels included in the image data as the center pixels, respectively. In the first embodiment, the center pixel is shifted in the horizontal direction of the image data one pixel by one pixel, and the processes at Steps S1402 to S1404 are performed for each of the center pixels.

The threshold calculating unit 103 then multiples the calculated difference average by the weight ω previously determined, to calculate the threshold th (Step S1403).

The edge-preserving filtering unit 104 then performs a smoothing process using the pixels in the block with the epsilon filter in which the calculated threshold th is set, thereby setting a pixel value of the center pixel (Step S1404). When these processes for all the pixels included in the image data are completed, the process ends.

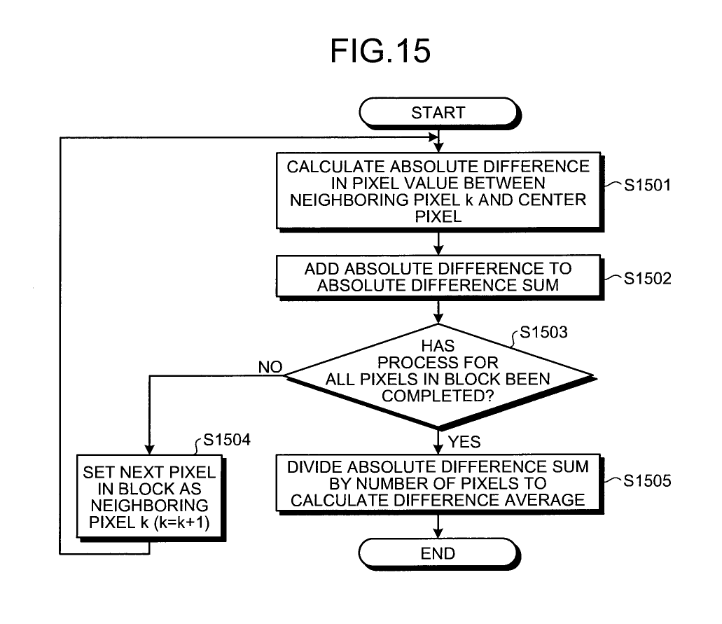

The procedure of calculating the difference average performed by the difference calculating unit 102 at Step S1402 in FIG. 14 according to the first embodiment is explained with reference to FIG. 15.

The difference calculating unit 102 first calculates an absolute difference in pixel values between a neighboring pixel k and the center pixel (Step S1501). It is assumed that an initial value of k is ‘1’.

The difference calculating unit 102 then adds the calculated absolute difference to an absolute difference sum (Step S1502). It is assumed that an initial value of the absolute difference sum is ‘0’.

The difference calculating unit 102 then determines whether the addition of the absolute difference has been completed for all the pixels in the block (Step S1503). When determining that the addition of the absolute difference has not been completed for all the pixels (NO at Step S1503), the difference calculating unit 102 sets the next pixel in the block as the neighboring pixel k (Step S1504).

Meanwhile, when determining that the addition of the absolute difference has been completed for all the pixels in the block (YES at Step S1503), the difference calculating unit 102 divides the absolute difference sum by the number of pixels, which is obtained by subtracting 1 (the center pixel) from the number of pixels in the block, to calculate the difference average (Step S1505).

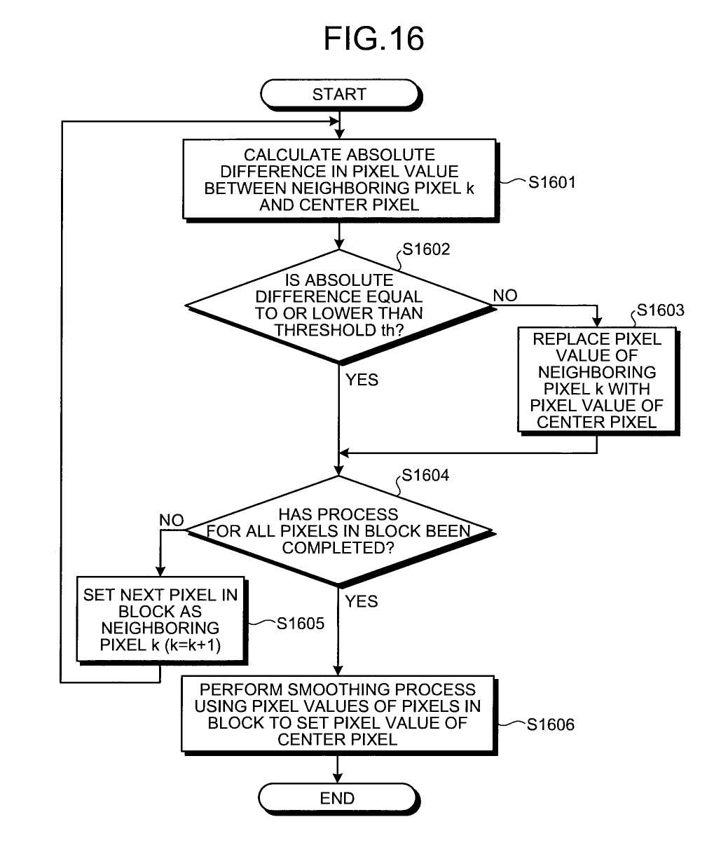

The smoothing process procedure performed by the edge-preserving filtering unit 104 at Step S1404 in FIG. 14 according to the first embodiment is explained next with reference to FIG. 16.

The edge-preserving filtering unit 104 first calculates an absolute difference in pixel values between a neighboring pixel k and a center pixel in the pixel block (Step S1601).

The edge-preserving filtering unit 104 then determines whether the absolute difference is equal to or lower than the threshold th (Step S1602). When determining that the absolute difference is equal to or lower than the threshold th (YES at Step S1602), the edge-preserving filtering unit 104 performs no process to the neighboring pixel.

Meanwhile, when determining that the absolute difference is higher the threshold th (NO at Step S1602), the edge-preserving filtering unit 104 replaces the pixel value of the neighboring pixel k with the pixel value of the center pixel (Step S1603).

The edge-preserving filtering unit 104 then determines whether the comparison with the threshold th for all the pixels in the pixel block has been completed (Step S1604). When determining that the comparison has not been completed (NO at Step S1604), the edge-preserving filtering unit 104 sets the next pixel in the block as the neighboring pixel k (Step S1605), and starts the processes from Step S1601 again.

Meanwhile, when determining that the comparison has been completed (YES at Step S1604), the edge-preserving filtering unit 104 performs a smoothing process using the pixels in the block, thereby setting the pixel value of the center pixel (Step S1606). In this process, an average value of all the pixels in the block after the replacement is set as the pixel value of the center pixel, for example.

By performing the smoothing process using the threshold th calculated in the process mentioned above, the image processing apparatus 100 can reduce small-signal noises while keeping signals regardless of whether image data including video signals with larger amplitude or image data including video signals with small amplitude is processed. The image processing apparatus 100 can also remove small-signal noises while keeping edges. Further, the image processing apparatus 100 can remove impulse noises, which cannot be well removed by the epsilon filter. Accordingly, the image processing apparatus 100 can generate image data with a high level of visibility.

The smoothing process using the threshold th calculated by using the difference average Ave and the weight ω can be applied not only to the image processing apparatus 100 according to the first embodiment, but also to an image processing apparatus that generates image data by synthesizing an illumination component and a contrast component to enhance contrast. In a second embodiment of the present invention, an example in which the smoothing process is applied to an image processing apparatus that enhances contrast is explained.

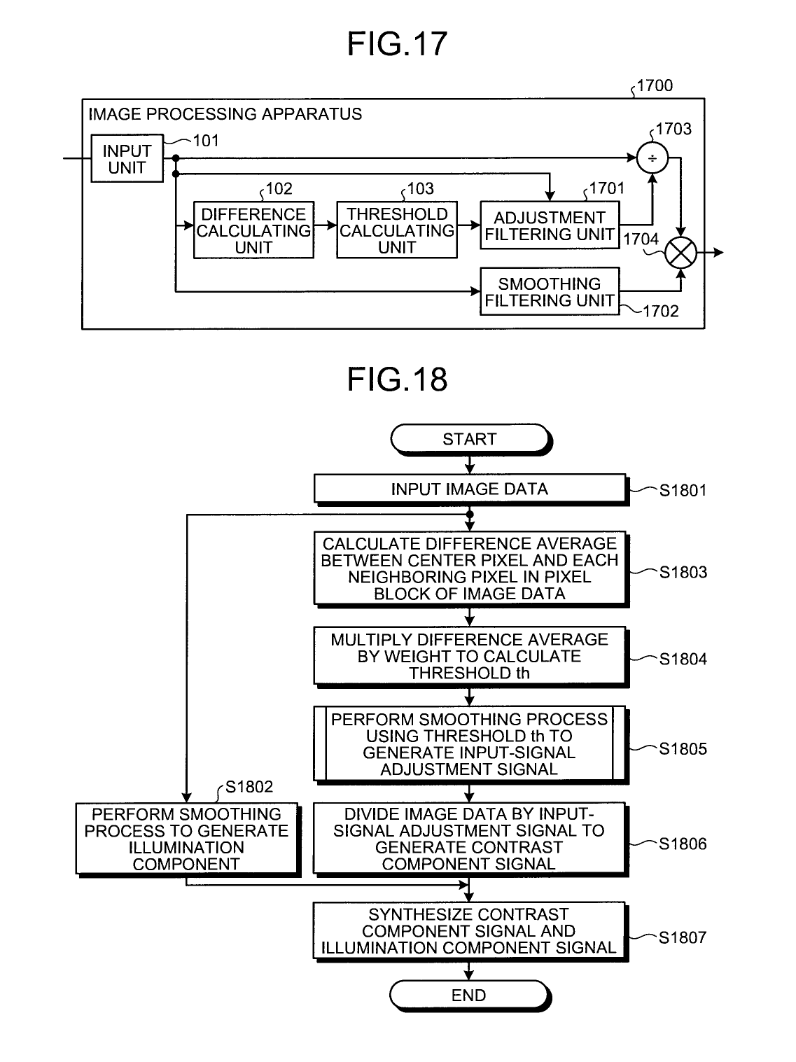

As shown in FIG. 17, an image processing apparatus 1700 according to the second embodiment includes the input unit 101, the difference calculating unit 102, the threshold calculating unit 103, an adjustment filtering unit 1701, a smoothing filtering unit 1702, a dividing unit 1703, and a synthesizing unit 1704. Constituent elements of the image processing apparatus 1700 according to the second embodiment, common to those in the image processing apparatus 100 according to the first embodiment are denoted by like reference numerals, and redundant explanations thereof will be omitted.

The smoothing filtering unit 1702 performs a smoothing process to image data inputted. The smoothing process is not limited to the one using the epsilon filter, and any smoothing process can be applied. In the second embodiment, when the epsilon filter is used, a threshold th′ different from the threshold th calculated by the threshold calculating unit 103 is used. However, the threshold th′ can be the same as the threshold th. A signal resulting from the smoothing process by the smoothing filtering unit 1702 is regarded as an illumination component signal.

The adjustment filtering unit 1701 performs a smoothing process using the threshold th calculated by the threshold calculating unit 103 with a modified epsilon filter, which is obtained by modifying the epsilon filter.

The modified epsilon filter calculates an absolute difference in signal levels between a center pixel of a block to be filtered and a neighboring pixel. The modified epsilon filter keeps a pixel value of the neighboring pixel when the calculated absolute difference is equal to or higher than the threshold th, and replaces the pixel value of the neighboring pixel with the pixel value of the center pixel when the absolute difference is lower than the threshold th, and then performs the smoothing process. In other words, the condition of the replacement with the pixel value of the center pixel is opposite to that in the first embodiment. That is, an input-signal adjustment signal outputted as a result of the smoothing process performed by the adjustment filtering unit 1701 has equivalent characteristics as those of the input signal, and has no edge component preserved and noise components included.

The dividing unit 1703 divides the input signal representing the inputted image data by the input-signal adjustment signal to generate a contrast component signal of the image data. Because the input-signal adjustment signal is a signal having no edge component preserved and the noise components included, the contrast component signal resulting from the division by the input-signal adjustment signal becomes a component signal in which the edge components are preserved and no noise component is included.

The synthesizing unit 1704 synthesizes the contrast component signal inputted from the dividing unit 1703 and the illumination component signal inputted from the smoothing filtering unit 1702 to generate synthesized image data.

A general process procedure performed by the image processing apparatus 1700 according to the second embodiment is explained with reference to FIG. 18.

The input unit 101 first performs a process of inputting image data (Step S1801).

The smoothing filtering unit 1702 then performs a smoothing process for the inputted image data to generate an illumination component signal (Step S1802). The illumination component signal generated at Step S1802 is used at Step S1807.

Meanwhile, the difference calculating unit 102 calculates a difference average, which is an average value of absolute differences between a center pixel and neighboring pixels in a pixel block included in the image data (Step S1803). Processes at Steps S1803 to S1806 are performed with respect to each center pixel with regarding each of all pixels in the image data as a center pixel. In the second embodiment, the center pixel is shifted in the horizontal direction of the image data one pixel by one pixel, and the processes at Steps S1803 to S1806 are performed with respect to each of the center pixels.

The threshold calculating unit 103 then multiplies the calculated difference average by the weight ω previously determined, to calculate the threshold th (Step S1804).

The adjustment filtering unit 1701 then performs a smoothing process using pixels included in the block by means of the modified epsilon filter in which the calculated threshold th is set, to generate an input-signal adjustment signal (Step S1805).

The dividing unit 1703 then divides the input signal representing the inputted image data by the input-signal adjustment signal to generate a contrast component signal (Step S1806).

The synthesizing unit 1704 then synthesizes the contrast component signal and the illumination component signal to generate synthesized image data (Step S1807).

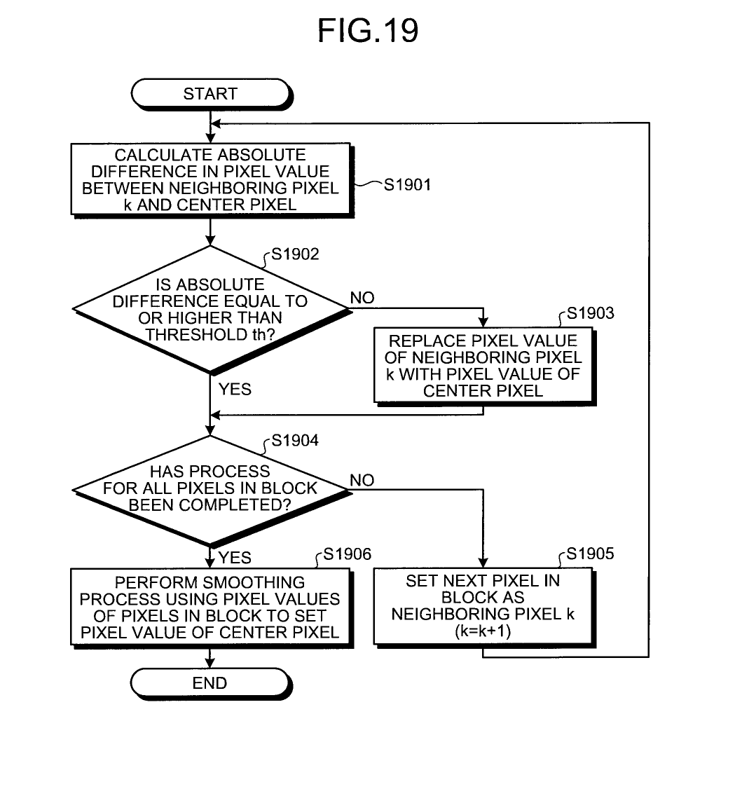

The smoothing process procedure performed by the adjustment filtering unit 1701 at Step S1805 in FIG. 18 according to the second embodiment is explained next with reference to FIG. 19.

The adjustment filtering unit 1701 first calculates an absolute difference in pixel values between a neighboring pixel k and a center pixel in a pixel block (Step S1901).

The adjustment filtering unit 1701 then determines whether the absolute difference is equal to or higher than the threshold th (Step S1902). When determining that the absolute difference is equal to or higher than the threshold th (YES at Step S1902), the adjustment filtering unit 1701 performs no process to the neighboring pixel k.

Meanwhile, when determining that the absolute difference is smaller than the threshold th (NO at Step S1902), the adjustment filtering unit 1701 replaces the pixel value of the neighboring pixel k with the pixel value of the center pixel (Step S1903).

The adjustment filtering unit 1701 then determines whether the comparison with the threshold th has been completed for all the pixels in the pixel block (Step S1904). When determining that the comparison has not been completed for all the pixels (NO at Step S1904), the adjustment filtering unit 1701 sets the next pixel in the block as the neighboring pixel k (Step S1905), and starts the processes from Step S1901 again.

Meanwhile, when determining that the comparison has been completed for all the pixels (YES at Step S1904), the adjustment filtering unit 1701 performs a smoothing process using the pixels in the block, thereby setting the pixel value of the center pixel (Step S1906). In this process, an average value of all the pixels in the block after the replacement is set as the pixel value of the center pixel, for example.

The image processing apparatus 1700 according to the second embodiment can achieve adjustment of the contrast of the image data, in addition to the effect achieved according to the first embodiment.

The image processing apparatus 1700 according to the second embodiment performs the smoothing process using the threshold th only for the input-signal adjustment signal to be used for generation of the contrast component signal. However, the smoothing process using the calculated threshold th can be also applied to the illumination component signal. In a third embodiment of the present invention, an example in which the smoothing process using the threshold th is applied to the illumination component signal is explained.

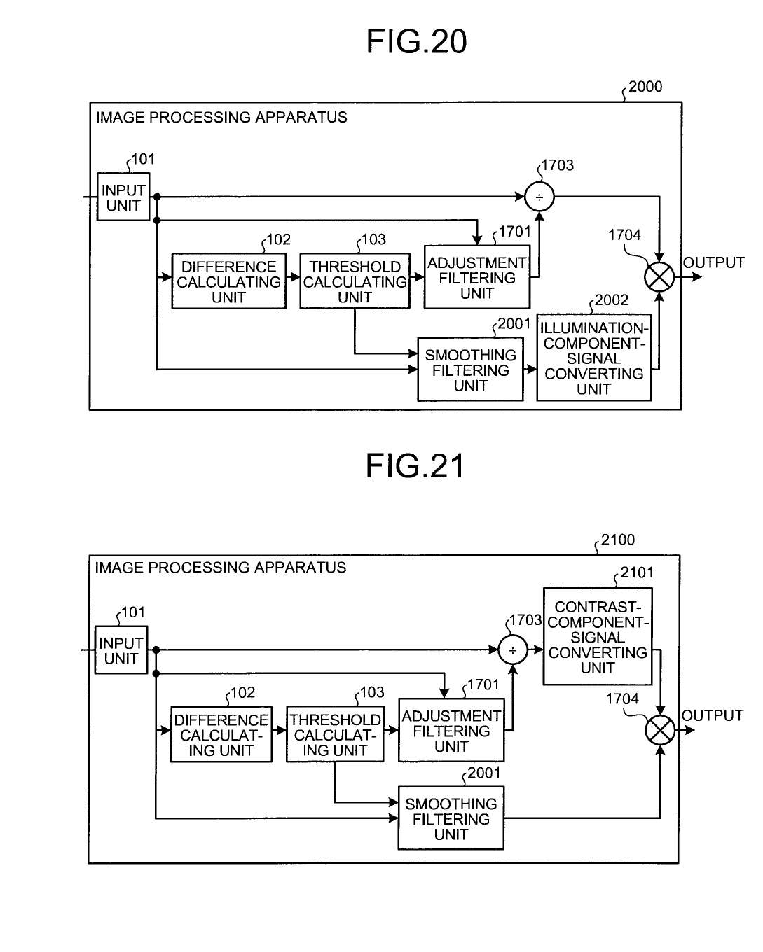

An image processing apparatus 2000 as shown in FIG. 20 is different from the image processing apparatus 1700 according to the second embodiment only in that a smoothing filtering unit 2001 that performs a different process from that of the smoothing filtering unit 1702 is provided instead and that an illumination-component-signal converting unit 2002 is added. Constituent elements of the image processing apparatus 2000 according to the third embodiment, common to those of the image processing apparatus 1700 according to the second embodiment are denoted by like reference numerals, and redundant explanations thereof will be omitted.

The smoothing filtering unit 2001 performs a smoothing process with respect to each of center pixels using pixel values of neighboring pixels of the center pixel and the threshold th calculated by the threshold calculating unit 103, by means of the edge-preserving smoothing filter, to generate an illumination component signal.

The illumination-component-signal converting unit 2002 performs a level conversion (decompression or compression) of the illumination component signal.

The illumination-component-signal converting unit 2002 converts the signal level to perform dynamic range compression of an image, enhancement of brightness of dark image data, or the like, thereby obtaining image data having a high level of visibility. For example, to compress the dynamic range, the illumination-component-signal converting unit 2002 performs compression of the illumination component signal. To enhance the brightness of dark image data, the illumination-component-signal converting unit 2002 performs level conversion from a dark signal to a bright signal.

A process procedure performed by the image processing apparatus 2000 is the same as that according to the second embodiment except that the illumination-component-signal converting unit 2002 performs the level conversion of the illumination component signal generated by the smoothing process using the threshold th. Accordingly, redundant explanations thereof will be omitted.

The image processing apparatus 2000 according to the third embodiment can obtain image data having a higher level of visibility according to the level conversion of the illumination component signal, in addition to the same effect as that of the image processing apparatus 1700 according to the second embodiment.

In the third embodiment, the level conversion of the illumination component signal is performed. However, the signals to be subjected to the level conversion are not limited to the illumination component signal. An example in which the level conversion of a contrast component signal is performed is explained in a first modification of the third embodiment.

As shown in FIG. 21, an image processing apparatus 2100 according to the first modification of the third embodiment is different from the image processing apparatus 2000 according to the third embodiment only in that the illumination-component-signal converting unit 2002 is eliminated and that a contrast-component-signal converting unit 2101 is added. Constituent elements of the image processing apparatus 2100 according to the first modification, common to those of the image processing apparatus 2000 according to the third embodiment are denoted by like reference numerals, and redundant explanations thereof will be omitted.

The contrast-component-signal converting unit 2101 performs level conversion (decompression or compression) of a contrast component signal generated by the dividing unit 1703.

By the contrast-component-signal converting unit 2101 converting a signal level of the contrast component signal, decompression or compression of the contrast (for example, an edge or texture component) of the image can be achieved. The contrast-component-signal converting unit 2101 also can reduce noises by converting the signal level.

For example, to enhance the contrast, the contrast-component-signal converting unit 2101 decompresses the contrast component signal. To reduce the contrast of an image or reduce noises of an image having many noises, the contrast-component-signal converting unit 2101 compresses the contrast component signal.

The decompression or compression of the contrast component signal performed by the contrast-component-signal converting unit 2101 according to the first modification can be realized by any method regardless of whether it is well known. For example, the contrast-component-signal converting unit 2101 can raise the contrast component to the second power when the contrast component is to be decompressed, and raise the contrast component to the one-half power when the contrast component is to be compressed.

In another example, the contrast-component-signal converting unit 2101 can multiply the contrast component by a value larger than 1 when the contrast component is to be decompressed, and multiply the contrast component by a value smaller than 1 when the contrast component is to be compressed.

Another example of the signal conversion, which is performed for an illumination component and a contrast component, respectively, is explained in a second modification of the third embodiment.

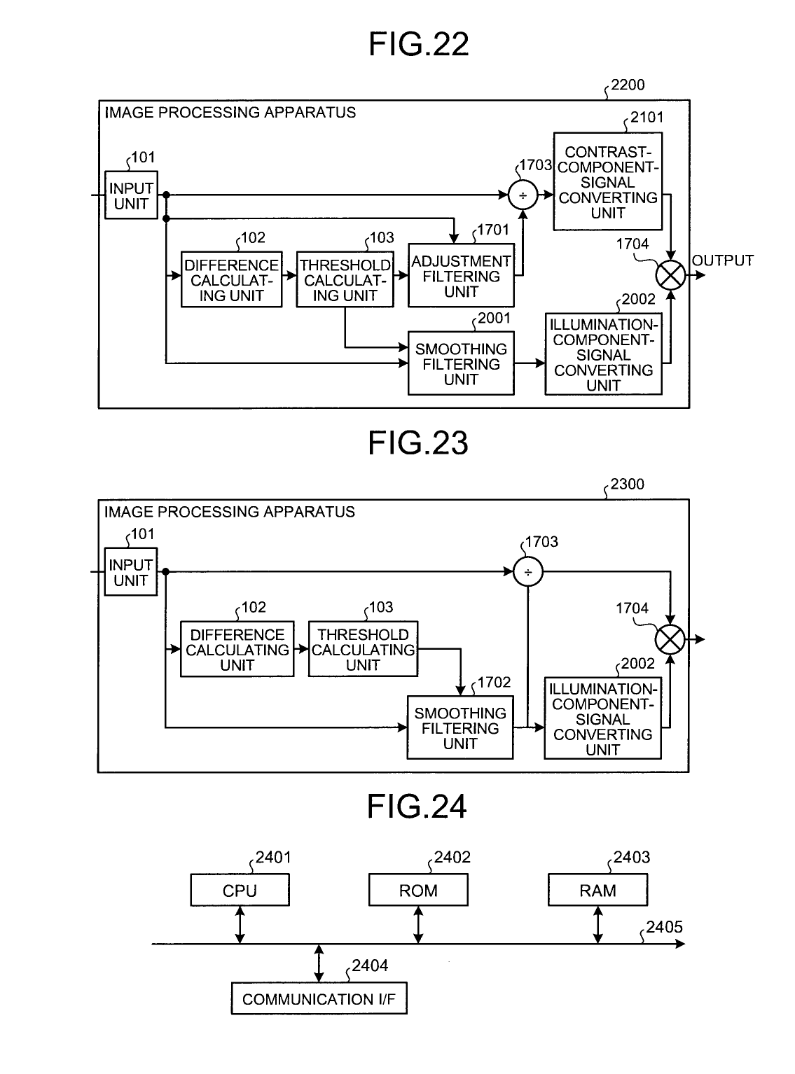

An image processing apparatus 2200 shown in FIG. 22 is different from the image processing apparatus 2100 according to the first modification of the third embodiment only in that the illumination-component-signal converting unit 2002 is added. Constituent elements of the image processing apparatus 2200 according to the second modification, common to those of the image processing apparatus 2000 according to the third embodiment or the image processing apparatus 2100 according to the first modification of the third embodiment are not explained.

Because the image processing apparatus 2200 has the configuration mentioned above, the illumination-component-signal converting unit 2002 can compress the illumination component signal, and the contrast-component-signal converting unit 2101 can decompress the contrast component signal. Accordingly, the image processing apparatus 2200 can generate an image having the contrast (an edge or texture component, for example) enhanced while compressing the dynamic range.

The present invention is not limited to the embodiments mentioned above, and various modifications can be made. For example, as shown in FIG. 23, an image processing apparatus 2300 includes the input unit 101, the difference calculating unit 102, the threshold calculating unit 103, the smoothing filtering unit 1702, the dividing unit 1703, the synthesizing unit 1704, and the illumination-component-signal converting unit 2002. In the image processing apparatus 2300 as shown in FIG. 23, the threshold setting method as described above is applied to a typical smoothing filter that performs a Retinex process.

In this way, the threshold setting method as described above can be applied to image processing apparatuses that perform various smoothing processes.

The image processing apparatus 2200 shown in FIG. 22 does not necessarily need to include both of the contrast-component-signal converting unit 2101 and the illumination-component-signal converting unit 2002. One or both thereof can be eliminated.

As shown in FIG. 24, the image processing apparatuses (100, 1700, 2000, 2100, 2200, and 2300) according to the embodiments described above each has a hardware configuration including a read only memory (ROM) 2402 that stores therein an image processing program that enables to perform the processes mentioned above, and the like, a central processing unit (CPU) 2401 that controls the constituent elements of the image processing apparatuses (100, 1700, 2000, 2100, 2200, and 2300) according to the program in the ROM 2402, a random access memory (RAM) 2403 as a data storage area, a communication interface (I/F) 2404 that connects to a network to establish communications for enabling input or output of moving images, and a bus 2405 that connects these constituent elements.

The image processing program can be provided by being recorded in a computer-readable recording medium such as an optical disk, a magnetic disk, and a solid state disk (SSD) in a file of an installable or executable form.

In this case, the image processing program is read from the recording medium and executed by the image processing apparatus (100, 1700, 2000, 2100, 2200, or 2300) to be loaded on the RAM 2403, so that the constituent elements as described above are generated on the RAM 2403 as the software configuration.

The image processing programs according to the embodiments mentioned above can be stored in a computer connected to a network such as the Internet, and downloaded through the network.

For example, an image processing method includes inputting an image, firstly calculating an absolute difference in pixel values between each pixel (target pixel) of the image and each of neighboring pixels of the target pixel, and a sum of the absolute differences with respect to the target pixel, secondly calculating a threshold using the sum of the absolute differences with respect to the target pixel and a weight previously determined, the threshold being used as a reference for determining whether the pixel values of the neighboring pixels are used in a smoothing process for the target pixel, and performing a smoothing process by means of an edge-preserving smoothing filter, based on whether the absolute difference in pixel values between the target pixel and each of the neighboring pixels of the target pixel exceeds the threshold.

In another case, an image processing method includes inputting an image, firstly performing a smoothing process for a luminance value included in the image by means of a smoothing filter, to generate smoothing information of each pixel, firstly calculating an absolute difference in pixel values between each pixel (target pixel) in the image and each of neighboring pixels of the target pixel, and a sum of the absolute differences with respect to the target pixel, secondly calculating a threshold using the sum of the absolute differences of the target pixel and a weight previously determined, the threshold being used as a reference for determined whether the pixel values of the neighboring pixels are used in a smoothing process for the target pixel, secondly performing a smoothing process using the pixel value of the target pixel as the pixel value of each of the neighboring pixels of the target pixel, having the absolute difference in pixel values between the target pixel and the neighboring pixel lower than the threshold, to generate adjustment information, dividing the pixel value of each pixel in the image by the adjustment information to generate contrast component information of each pixel of the image, and multiplying the contrast component information by the smoothing information to generate synthesized image.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image processing apparatus comprising:
an input unit that inputs an image;
a difference calculating unit that calculates an absolute difference in pixel values between each pixel (target pixel) of the image and each of neighboring pixels of the target pixel, and a sum of the absolute differences with respect to the target pixel;
a threshold calculating unit that calculates a threshold using the sum of the absolute differences with respect to the target pixel and a weight previously determined, the threshold being used as a reference for determining whether the pixel values of the neighboring pixels are used in a smoothing process for the target pixel; and
a filtering unit that performs a smoothing process by means of an edge-preserving smoothing filter, based on whether the absolute difference in pixel values between the target pixel and each of the neighboring pixels of the target pixel exceeds the threshold.

2. The apparatus according to claim 1, wherein the weight used by the threshold calculating unit is previously calculated based on an absolute difference sum of edges and an absolute difference sum of noises, when the neighboring pixels of each of the target pixels are divided into edges and noises based on the number of pixels among the neighboring pixels, having the absolute difference that is equal to or higher than a value previously determined.

3. The apparatus according to claim 2, wherein the filtering unit performs the smoothing process using only the neighboring pixels having the absolute difference equal to or lower than the threshold.

4. The apparatus according to claim 2, wherein the filtering unit performs the smoothing process using the pixel value of the target pixel as the pixel values of the neighboring pixels having the absolute differences higher than the threshold.

5. The apparatus according to claim 1, wherein
the difference calculating unit calculates a difference square sum indicating a square sum of differences between the target pixel and the neighboring pixels of the target pixel, instead of the absolute difference sum, and
the threshold calculating unit calculates a threshold by an operation using the difference square sum and a weight previously determined, the threshold being used as a reference for determining whether the pixel values of the neighboring pixels are used in the smoothing process.

6. An image processing apparatus comprising:
an input unit that inputs an image;
a smoothing filtering unit that performs a smoothing process for a luminance value included in the image by means of a smoothing filter, to generate smoothing information of each pixel;
a difference calculating unit that calculates an absolute difference in pixel values between each pixel (target pixel) in the image and each of neighboring pixels of the target pixel, and a sum of the absolute differences with respect to the target pixel;
a threshold calculating unit that calculates a threshold using the sum of the absolute differences of the target pixel and a weight previously determined, the threshold being used as a reference for determined whether the pixel values of the neighboring pixels are used in a smoothing process for the target pixel;
an adjustment filtering unit that performs a smoothing process using the pixel value of the target pixel as the pixel value of each of the neighboring pixels of the target pixel, having the absolute difference in pixel values between the target pixel and the neighboring pixel lower than the threshold, to generate adjustment information;
a contrast-component generating unit that divides the pixel value of each pixel in the image by the adjustment information to generate contrast component information of each pixel of the image; and
an image synthesizing unit that multiplies the contrast component information by the smoothing information to generate synthesized image.

7. The apparatus according to claim 6, wherein the weight used by the threshold calculating unit is previously calculated based on an absolute difference sum of edges and an absolute difference sum of noises, when the neighboring pixels of each of the target pixels are divided into edges and noises based on the number of pixels among the neighboring pixels, having the absolute difference that is equal to or higher than a value previously determined.

8. The apparatus according to claim 6, wherein the smoothing filtering unit performs the smoothing process using the pixel value of each of the neighboring pixels of the target pixel when the absolute difference in pixel values between the target pixel and the neighboring pixel is equal to or lower than the threshold, and using the pixel value of the target pixel instead of the pixel value of the neighboring pixel when the absolute difference is higher than the threshold.
